(19) United States
(12) Patent Application Publication
(10) Pub. No.: US 2013/0117166 A1
(43) Pub. Date: May 9, 2013

(54) ASSET MANAGEMENT SYSTEM AND A METHOD FOR ENABLING A PERSON TO FIND A LOCATION WITHIN AN AREA OF SPACE

(71) Applicant: Andrew Turner, Heighington (GB)

(72) Inventor: Andrew Turner, Heighington (GB)

(73) Assignee: 3C VISUAL MATRIX LTD, Darlington, County Durham (GB)

(21) Appl. No.: 13/806,557

(22) PCT Filed: Jun. 27, 2011
(86) PCT No.: PCT/GB11/51212

§ 371 Date: Jan. 18, 2013

(30) Foreign Application Priority Data
Jun. 25, 2010 (GB) 1010744.9

(51) Int. Cl. G06Q 10/08

(52) U.S. Cl. CPC G06Q 10/087
USPC 705/28

(57) ABSTRACT

A method for enabling a person to find a first location within an area of space. The method comprising the steps of dividing an area into a plurality of distinguishable sub-areas, dividing each sub-area into a grid, providing a person with information concerning the distribution of the sub-areas within the area, providing the person with information concerning a first sub-area in which a first location resides within the area, and providing the person with information concerning the grid reference of the first location within the first sub-area. An asset management system is also disclosed that preferably incorporates the above grid reference system.

The present invention relates to an asset management system and to a method for enabling a person to find a first location within an area. The invention relates particularly, but not exclusively, to an asset management system for tracking and managing assets on large work sites and to a method of finding objects, resources and locations in a building or on a work site.

The keeping of asset registers on work sites is well known and many asset data management systems exist to record information about assets. However, the utilisation of the data contained within the asset register is often very limited and not presented to a user in an easily accessible manner. Furthermore, duplication of data can lead to errors and is inefficient in the use of storage space.

Maps are widely used to enable people to find specific locations within an area of space. To assist in locating a specific place within the area, a map can be divided by a grid to create grid squares which are referred to by letter and/or number. When a person uses a map to find a location within an area they use an index to identify the grid reference of the place they want to go to which then reduces the area of the map to just the grid square which the person has to look in. However, if a map is divided up into many grid squares the co-ordinates used to identify each grid square on that map become complex. The more complex a co-ordinate becomes the less likely it will be that a person will be able to remember the grid reference.

Preferred embodiments of the present invention seek to overcome the above disadvantages of the prior art.

According to an aspect of the present invention, there is provided an asset management system comprising:—

at least one data storage device for storing data, the data including:
map data for allowing a map or plan to be displayed on a display device;
grid data for allowing a plurality of grids to be displayed on a display device, each grid formed from a plurality of grid sectors, the grid data forming at least one first grid and at least one second grid the extremities of said second grid being substantially the edges of a sector of said first grid;
asset data including asset location data relating to a location of an asset and asset feature data relating to features of said asset;
logic test data relating to at least one logic test that can be applied to at least some of said asset data;
linking data for linking grid sectors to other data wherein grid sectors are linked to one or more of:
   a further grid, the extremities of said further grid being the edges of said selected grid section;
   at least one datum of said asset data; and
   at least one said logic test data; and
      at least one processing device for processing said data and displaying, on at least one display device, at least one first map image representing at least some of said map data and at least one grid representing at least some of said grid data, said processing device adapted to receive input data relating to the selection of a grid sector by a user, wherein said selection causes said processing device to process at least some of said data to produce at least one of the following actions:
displaying a portion of said map data contained within said selected sector and display a further grid;
displaying at least one datum of said asset data; and
applying a logic test defined by said logic test data and displaying the results thereof,
   wherein at least one of said logic tests is to identify all grid sectors that are linked by said linking data to at least one asset feature datum defined in the logic test.

By linking grid sectors to asset data and to logic tests, in particular a logic test that identifies all grid sectors that are linked to an asset feature defined in the logic test, the advantage is provided that the user can identify assets that are relevant to, or linked to, a particular asset feature and to identify locations within a site where the identified assets are located. As an example, a user may locate an asset by knowing the location of the asset and clicking through one or more grid sectors to find an asset. Once an asset is located, selecting that asset displays further information about the asset with a grid overlay and grid sectors contain either asset data or logic tests to be applied to asset data. One sector may therefore contain an asset datum such as a relevant document and an adjacent sector may contain a logic test relevant to that document. This logic test may for example be to identify what other assets this document relevant to. All assets for which this is a relevant document should have linking data linking a grid sector linked to that asset to the document. As a result, the simple logic test can identify all assets for which a document is relevant. Furthermore, this is achieved by only requiring a single copy of the document, thereby reducing the data storage space required. The grid sectors defined above act like hyperlinks to redirect a user to a new display, for example zooming in on the map or displaying asset data. This mechanism operates in a manner familiar to those using hyperlinks where a linear forward or backward journey through data can be undertaken. However, the logic test described above provides an alternative means of accessing the data contained on the storage device by allowing a reverse or backwards movement through the data but in a non-linear manner by applying a logic test which identifies multiple sectors or assets.

In a preferred embodiment, the grid data is divided into grid sectors by dividing said grid into a plurality of sub-areas, each sub-area identifiable by a coordinate, a matrix is applied to each sub-area dividing the sub-area to give a plurality of grid-areas in each sub-area, each grid-area identifiable by a pair of coordinates, and a grid sector is identified in said grid by providing sub-area and grid-area information as at least 3 said coordinates.

By utilising a three co-ordinate system, the advantage is provided that large numbers of sectors can be provided in a grid whilst maintaining a very simple co-ordinate system with co-ordinates that can be easily described both visually and verbally. This allows the asset management system to be used effectively on a computer device but also allows the information to be transferred to people for example to indicate precisely where an asset is located.

In another preferred embodiment the asset location data is defined with reference to said grid data.

In another preferred embodiment the asset feature data includes at least one of documents related to said asset, images related to said asset, dimensions related to said asset and persons authorised to use said asset.

In another preferred embodiment the logic test data includes applying a logic test to at least one of said asset feature data, said asset location data and said linking data.

In another preferred embodiment when at least one datum of said asset data is displayed at least one grid is also displayed and at least one sector of said grid is linked to at least one other asset datum.

According to an aspect of the present invention there is provided an asset management method comprising the steps:—

storing data on at least one data storage device, the data including:
map data for allowing a map or plan to be displayed on a display device;
grid data for allowing a plurality of grids to be displayed on a display device, each grid formed from a plurality of grid sectors, the grid data forming at least one first grid and at least one second grid the extremities of said second grid being substantially the edges of a sector of said first grid;
asset data including asset location data relating to a location of an asset and asset feature data relating to features of said asset;
logic test data relating to at least one logic test that can be applied to at least some of said asset data;
linking data for linking grid sectors to other data wherein grid sectors are linked to one or more of:
   a further grid, the extremities of said further grid being the edges of said selected grid section;
   at least one datum of said asset data; and
   at least one said logic test data; and
      processing said data, on at least one processing device, and displaying, on at least one display device, at least one first map image representing at least some of said map data and at least one grid representing at least some of said grid data,
      receiving, on said processing device, input data relating to the selection of a grid sector by a user, wherein said selection causes said processing device to process at least some of said data to produce at least one of the following actions:
displaying a portion of said map data contained within said selected sector and display a further grid;
displaying at least one datum of said asset data; and
applying a logic test defined by said logic test data and displaying the results thereof,
   wherein at least one of said logic tests is to identify all grid sectors that are linked by said linking data to at least one asset feature datum defined in the logic test.

Preferred embodiments of the invention will now be described, by way of example only and not in any limitative sense, with reference to the accompanying drawings in which:—

According to a further aspect of the present invention there is provided an asset management computer program comprising:—

first computer code for storing data on at least one data storage device, the data including:
map data for allowing a map or plan to be displayed on a display device;
grid data for allowing a plurality of grids to be displayed on a display device, each grid formed from a plurality of grid sectors, the grid data forming at least one first grid and at least one second grid the extremities of said second grid being substantially the edges of a sector of said first grid;
asset data including asset location data relating to a location of an asset and asset feature data relating to features of said asset;
logic test data relating to at least one logic test that can be applied to at least some of said asset data;
linking data for linking grid sectors to other data wherein grid sectors are linked to one or more of:
   a further grid, the extremities of said further grid being the edges of said selected grid section;
   at least one datum of said asset data; and
   at least one said logic test data; and
      second computer code for processing said data, on at least one processing device, and displaying, on at least one display device, at least one first map image representing at least some of said map data and at least one grid representing at least some of said grid data,
      third computer code for receiving, on said processing device, input data relating to the selection of a grid sector by a user, wherein said selection causes said processing device to process at least some of said data to produce at least one of the following actions:
displaying a portion of said map data contained within said selected sector and display a further grid;
displaying at least one datum of said asset data; and
applying a logic test defined by said logic test data and displaying the results thereof,
   wherein at least one of said logic tests is to identify all grid sectors that are linked by said linking data to at least one asset feature datum defined in the logic test.

By providing a grid overlaying an asset datum, for example a photograph of the asset, the advantage is provided that it is clear to a user that they have reached details about a particular asset but further details, such as links to documents and further logic tests can still be provided with links via grid sectors. As a result, the data link system is very efficient in terms of data storage, as well as being instructive for users to operate.

According to another aspect of the present invention there is provided a method for enabling a person to identify a first location within an area, the method comprising:—
providing an image, in the form of a map, representing an area, the image including
   divisions of at least part of the image into a plurality of sub-areas, each sub-area identifiable by a coordinate, and
   a grid applied to each sub-area to give a plurality of grid-areas in each sub-area, each grid-area identifiable by a pair of coordinates; and
identifying a location in said area by providing sub-area and grid-area information as at least three said coordinates.

By dividing a map into a plurality of distinguishable sub-areas allows points within each sub-area to be labelled with simplified grid references. For example, a 20×20 giving 400 grid squares, may consist of four 10×10 grids each being distinguishable from the other by being shown in a different colour. Then instead of labelling a point with co-ordinate (19, 18) for example, it may be labelled RED (9,8). In this case, this reduces the number of integers that a person is required to remember in order to locate a point on the map by two. A person is more likely to remember a single colour and a simplified grid reference than a complicated numerical grid reference. The advantage is therefore provided of increasing the ease with which a person may remember the co-ordinates of a point on a map.

In a preferred embodiment systems for identifying said three coordinates are different for each of the three coordinates.

Furthermore, it does not matter in which order a person remembers the colour, letter and number making up the co-ordinate RED (C,3). Any arrangement of the colour, letter and number will still allow a person to locate the co-ordinate on a map. This provides the advantage of reducing the chances of a person incorrectly referencing the co-ordinates of a point on a map.

In another preferred embodiment the systems include three of colours; letters; numbers; and, line thicknesses.

Also, if the grid of a map is labelled with letters along its x-axis and with numerals along its y-axis, a co-ordinate for a point may be made to consist of a colour, a number and a letter, for example, RED (C,3). A person is more able to remember three separate things, for example, a colour, a number and a letter, than three separate numbers. This provides the advantage of further increasing the ease with which a person may remember the co-ordinates of a point on a map.

If a person is communicating to another person the location of a first object in an area of space, they need only communicate the grid reference of the first object within the area, for example, the colour of the sub-area in which the first object resides and the two integer grid reference within that sub-area, rather than define the location of the first object relative to other objects within the same area of space. This provides the advantage of increasing the ease and speed with which a person can communicate and subsequently find the location of an object residing in an area.

According to another embodiment of the present invention there is provided an apparatus for enabling a person to identify a first location within an area, the method comprising at least one display device for displaying an image, in the form of a map, representing an area, the image including
divisions of at least part of the image into a plurality of sub-areas, each sub-area identifiable by a coordinate, and
a grid applied to each sub-area to give a plurality of grid-areas in each sub-area, each grid-area identifiable by a pair of coordinates
wherein a location in said area can be identifies by providing sub-area and grid-area information as at least three said coordinates.

The apparatus may further comprise means for displaying on said map at least one icon representing at least one device at a location in said space and means for communicating said coordinates equivalent to said location.

In a preferred embodiment systems for identifying said three coordinates are different for each of the three coordinates.

In another preferred embodiment the systems include three of colours; letters; numbers; and, line thicknesses.

According to another aspect of the present invention there is provided a computer program for enabling a person to identify a first location within an area, the method comprising:—
first computer code for creating an image, in the form of a map, representing an area, the image including
   divisions of at least part of the image into a plurality of sub-areas, each sub-area identifiable by a coordinate, and
   a grid applied to each sub-area to give a plurality of grid-areas in each sub-area, each grid-area identifiable by a pair of coordinates; and
second computer code for identifying a location in said area by providing sub-area and grid-area information as at least three said coordinates.

In a preferred embodiment systems for identifying said three coordinates are different for each of the three coordinates.

In another preferred embodiment the systems include three of colours; letters; numbers; and, line thicknesses.

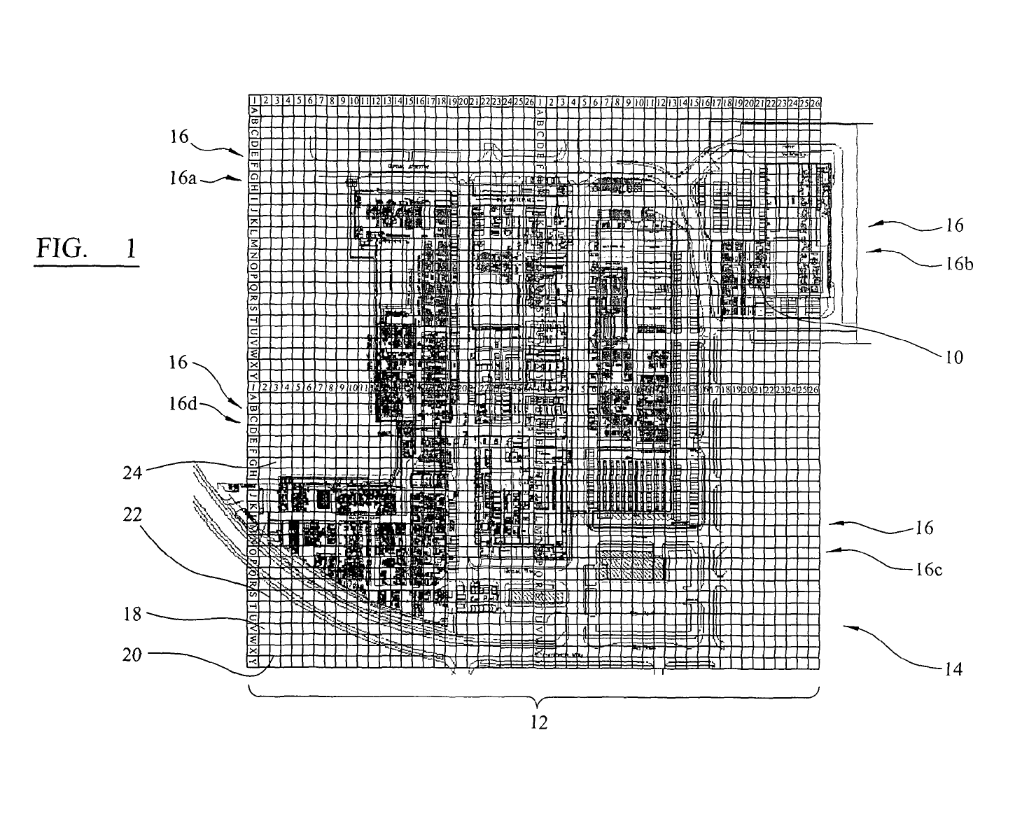

FIG. 1 is an example of a map used in the present invention;

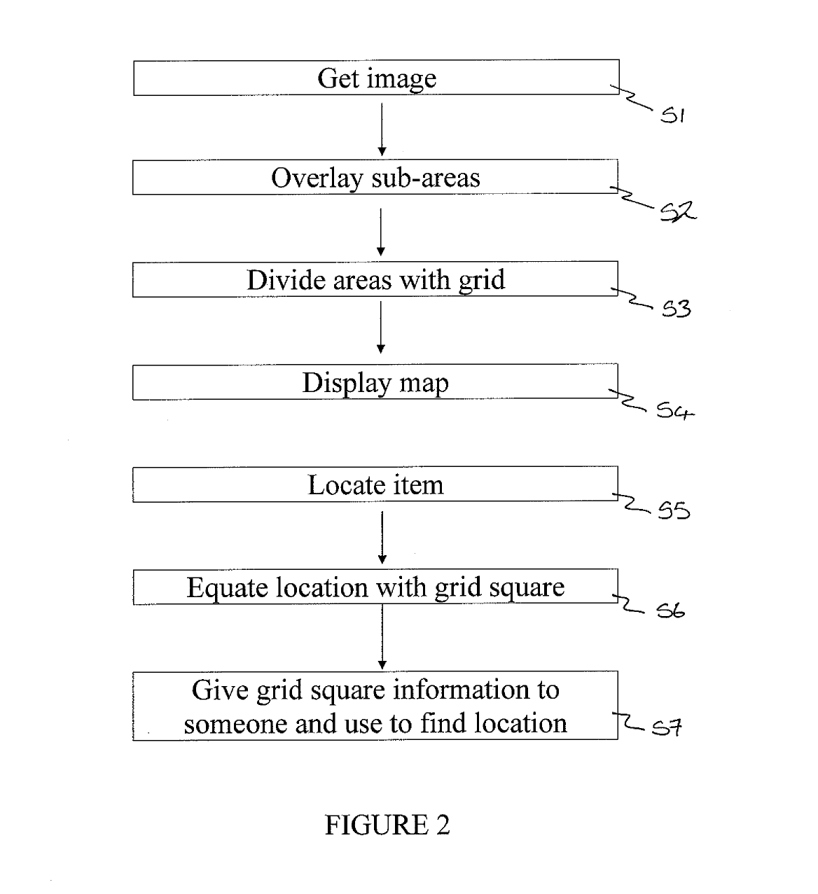

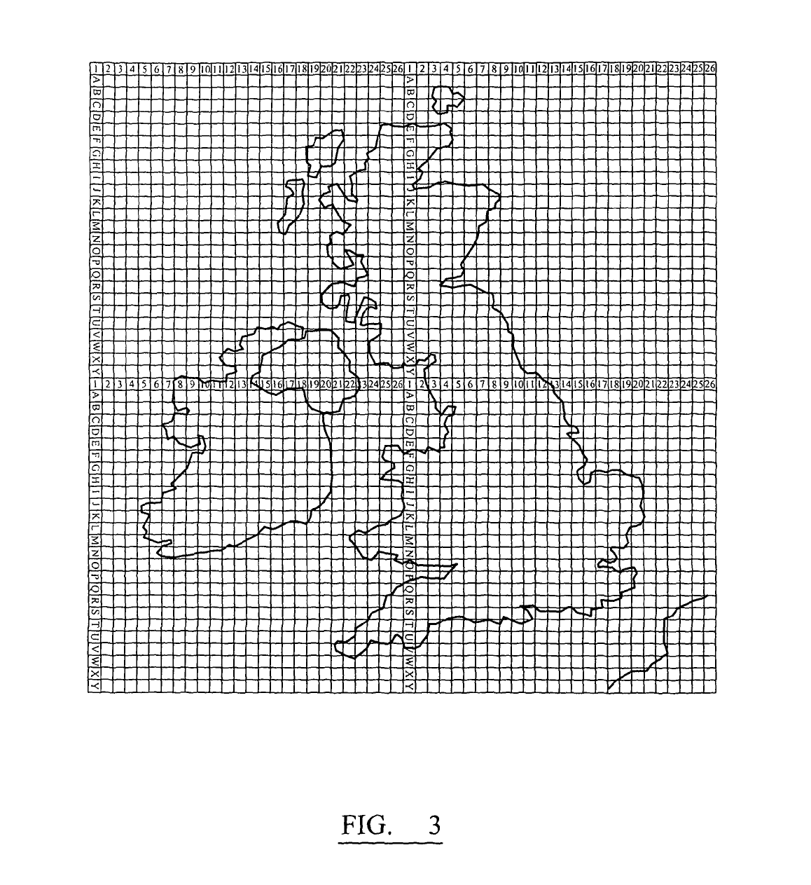

FIG. 2 is a flow chart showing steps used in the method of the present invention; and

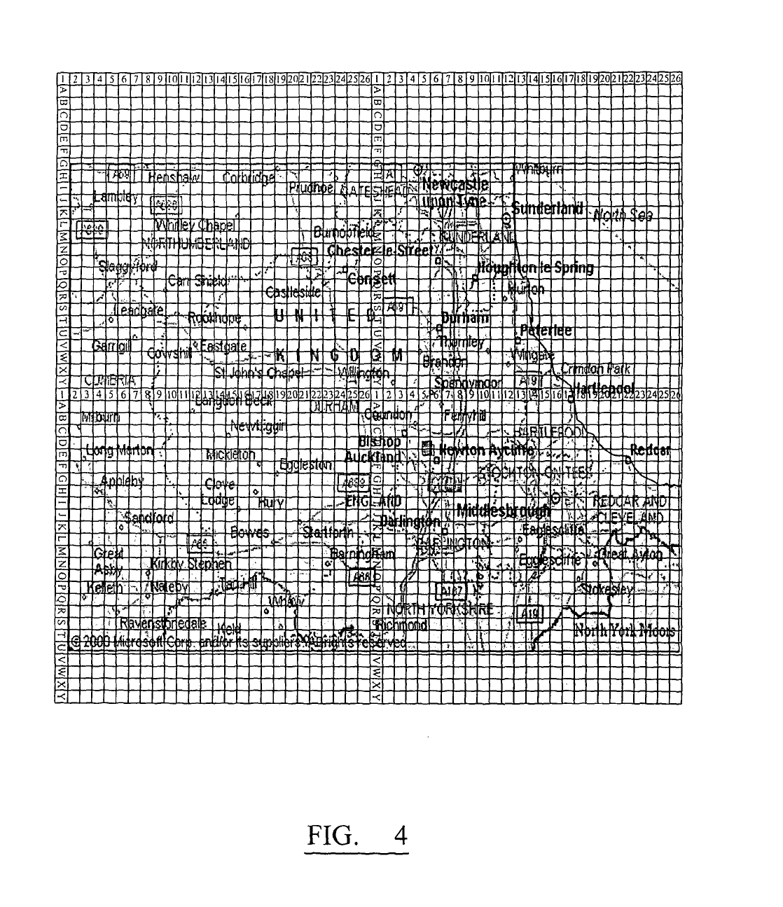

FIGS. 3 to 6 are further examples of maps used in the present invention;

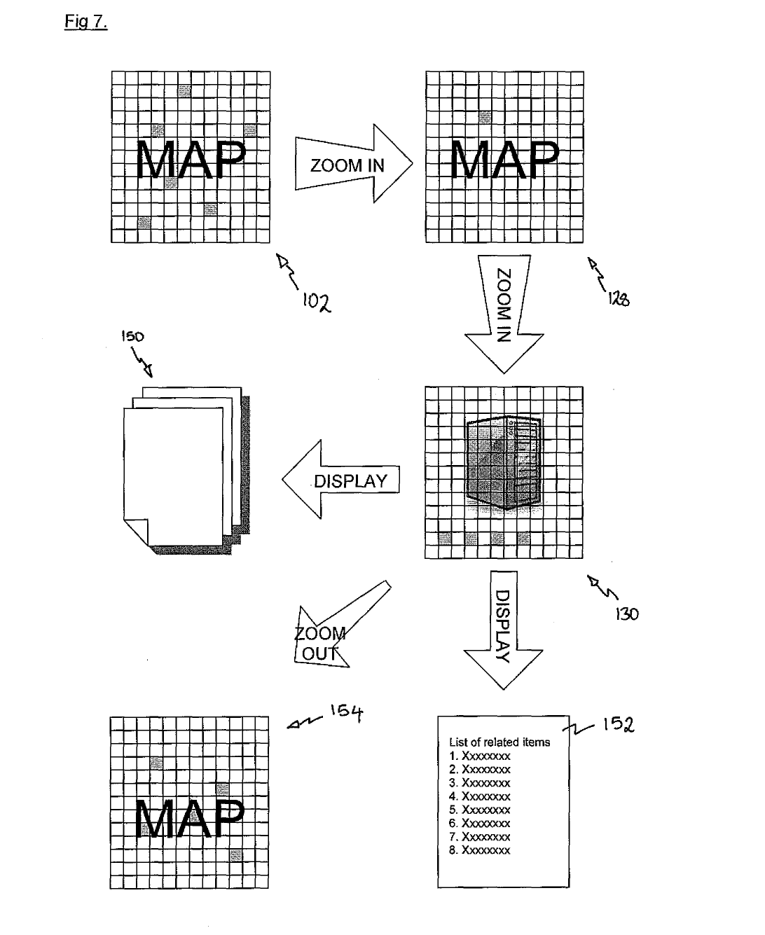

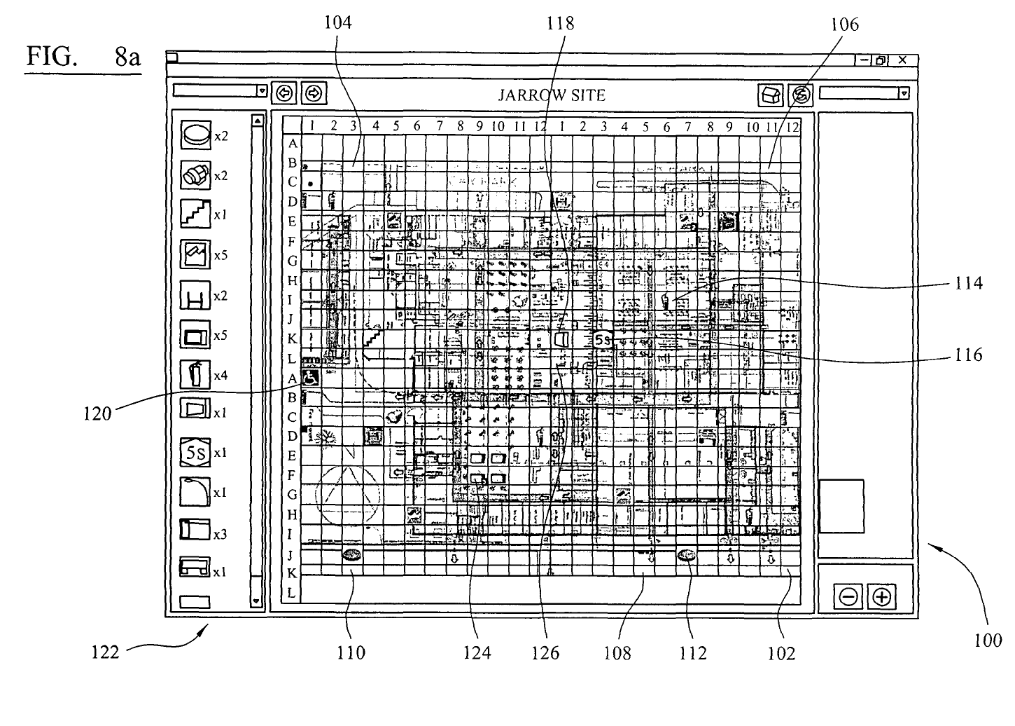

FIG. 7 is a schematic representation of the steps undertaken in another embodiment of the present invention;

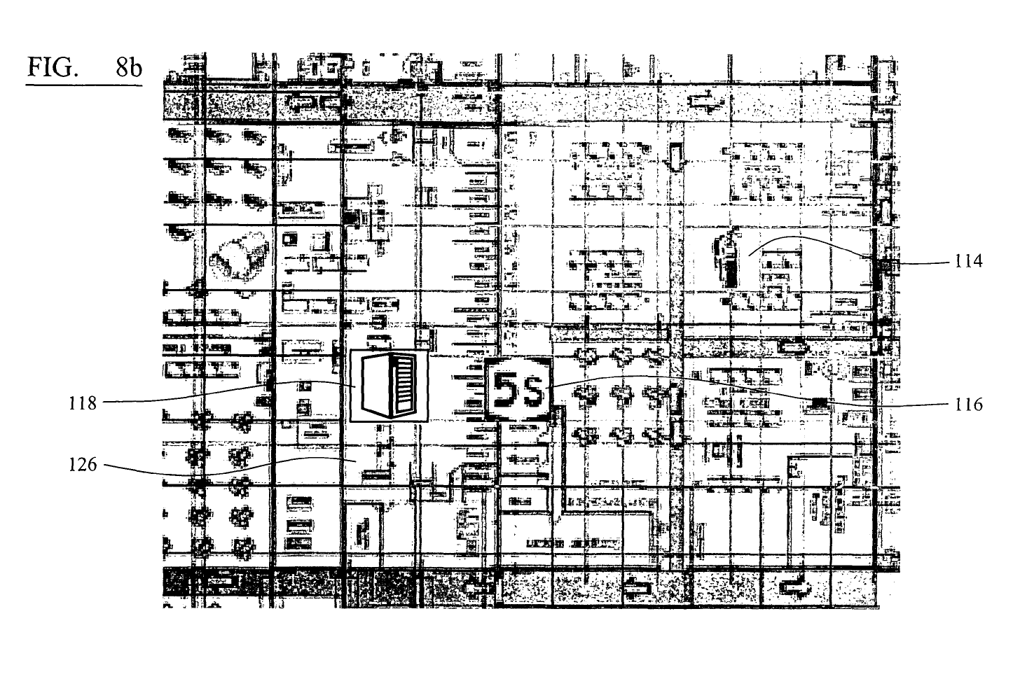

FIG. 8a is an example of a screen layout taken from a display device used the embodiment laid out in FIG. 7;

FIG. 8b is an enlarged portion of the screen layout of FIG. 8a; and

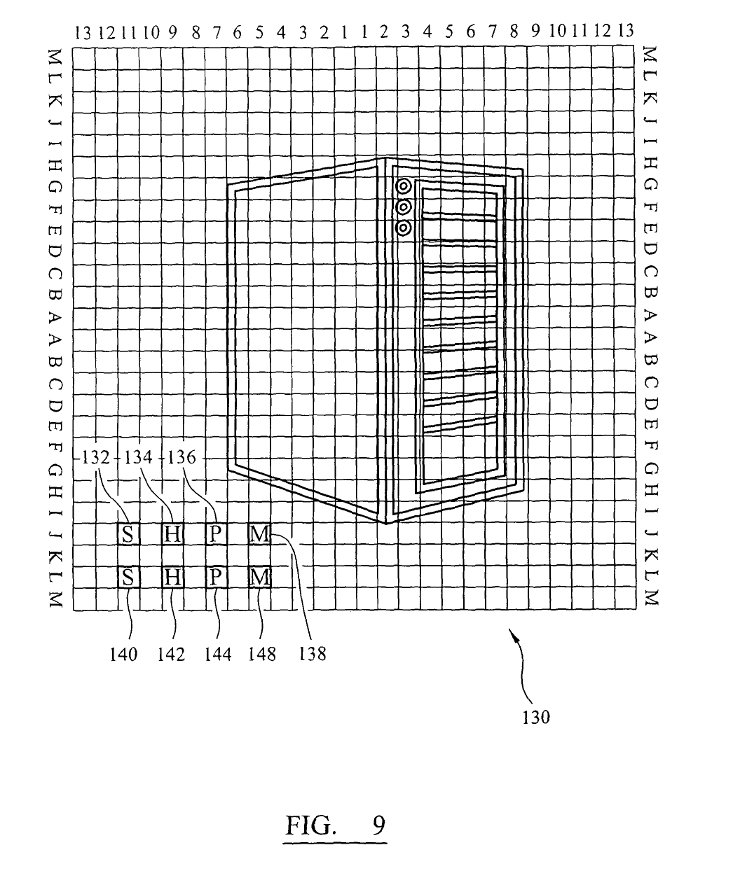

FIG. 9 is an example of a screen layout taken from a display device used the embodiment laid out in FIG. 7.

Referring to FIGS. 1 and 2 a method for enabling a person to identify a first location within an area 12 includes providing an image, in the form of a map 14 representing the area 12. The image is divided into a plurality of sub-areas 16. In the embodiment of the invention shown in FIG. 1 there are four areas 16a, 16b, 16c and 16d and each of these sub-areas 16 is identifiable by a coordinate. In the present example a colour within the present example sub-area 16a coloured green, sub-area 16b coloured yellow, sub-area 16c coloured blue and sub-area 16d coloured red.

A grid 18 is then applied to each sub-area 16 the grid being formed from a plurality of horizontal lines 20 and a plurality of vertical lines 22. Each sub-area has 27 horizontal lines 20 and 27 vertical lines 22 to produce a grid of 26×26 grid squares 24 covering the sub-area 16. The horizontal squares in each sub-area are labelled with letters of the alphabet and the vertical lines of grid squares are labelled with numbers 1 to 26. As a result, each of the 676 grid squares in each sub-area is identifiable by a pair of coordinates. Since each other area is also identifiable by a colour each of the 2704 grid squares in area 12 is identifiable using a three coordinate system of colour, letter and number.

The sub-areas are most easily identified by using grid lines that are coloured to the same colour coordinate as the sub-area 16. However, the name of that colour can be written beside the sub-area 16 so that it is clearly displayed and the map can be interpreted by people with colour blindness.

The map is now ready to be used.

An object at a first location 10 within area 12 can have its location identified using the three coordinate system of the present invention (step S5 and S6). These coordinates can be then easily given to another person and they are then able to quickly identify the location using the map shown in FIG. 1. Firstly the sub-area 16 is selected by matching to the colour referred to in the coordinate. From within this sub-area 16 the letter and number coordinates are used to identify the grid square 24 that the coordinates refer to (step S7).

If the map is displayed on a computer device, and the computer device is at a known location, (either because it is fixed at a specific location or it has position identification apparatus within it, for example GPS or RFID tags) software can be used to provide directions from the present location to the first location identified by the coordinates. Similarly apparatus that is located within the area of the map and that has position identification means can be displayed on the map by converting the position, for example as calculated using a GPS system, can feed its location information back to a centralised computer mapping system. This allows its location to be identified and transmitted to a person who can then find the item within the relatively small area of a grid square. Similar items can be displayed as an overlay on the map and this can be used in stock auditing and similar processes. Similarly fixed assets, that is those that are unlikely to move and are therefore not tracked using a location tracking device, can similarly be identified in a database of locations and these locations overlaid onto the map 14.

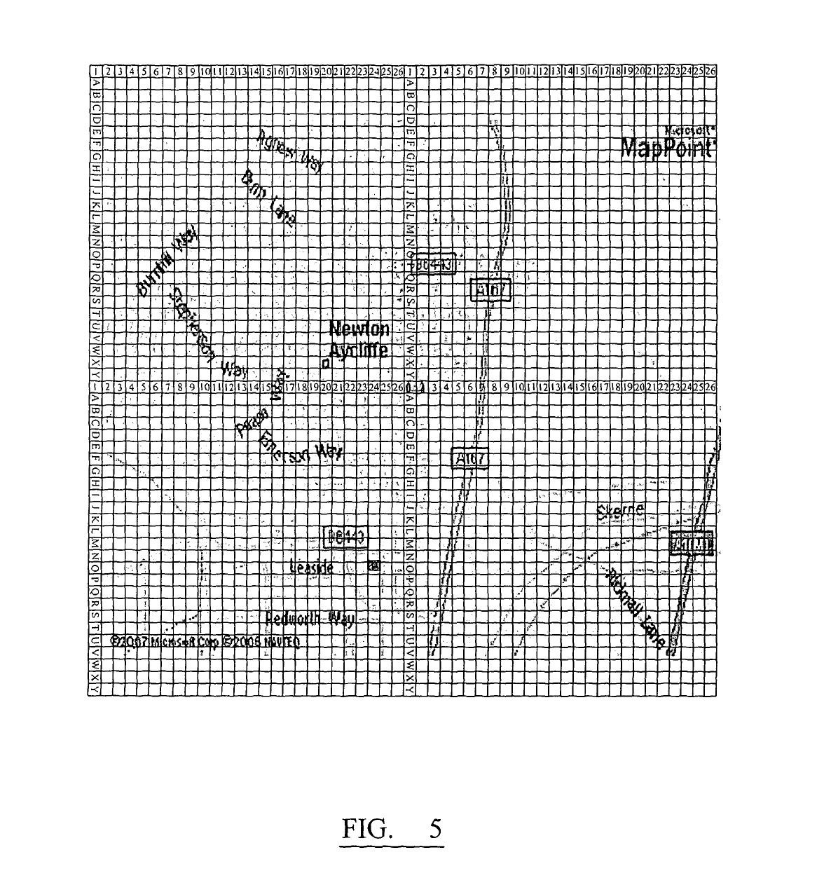

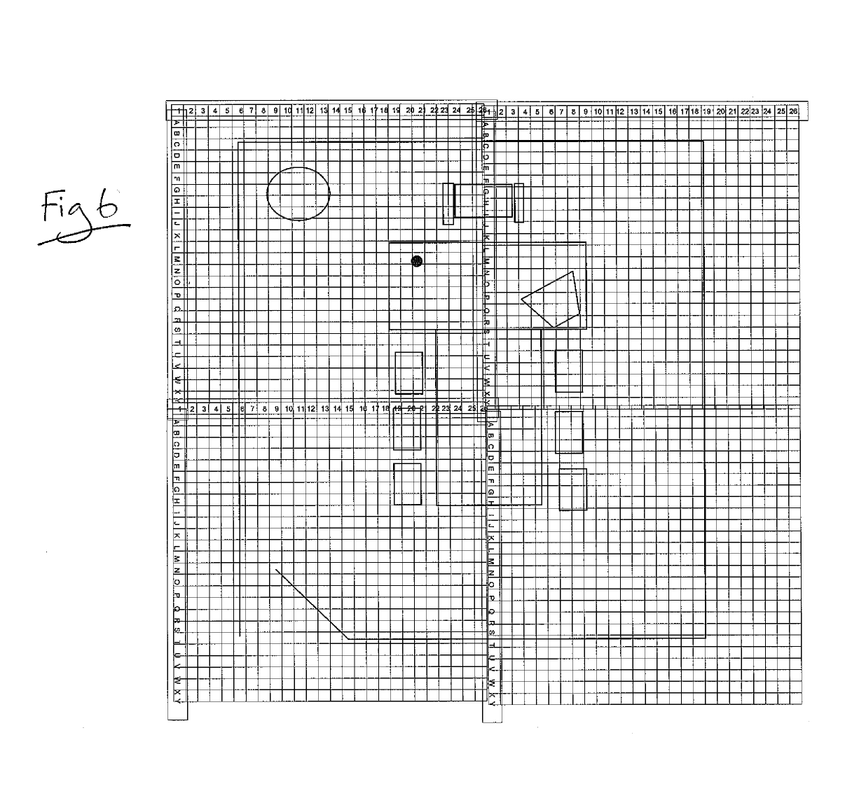

As demonstrated by FIGS. 1 and 2 to 6 greater levels of accuracy can be provided by the present invention by using a grid square 24 representing a first location 10 as the basis for a second map to be produced showing in greater detail the area covered by that grid square. This therefore allows a zooming-in function with each additional set of three coordinates adding a further 2704 grid squares of detail to the map. For example, FIG. 2 shows a map of the British Isles divided into 4×26×26 (that is 2704) grid squares. The grid square identified in FIG. 3 is shown in more detail in FIG. 4 in which the highlighted grid square (adjacent Newton Aycliffe) is represented in FIG. 5 as a further map covered by more grid squares. A grid square identified adjacent Leaside in FIG. 5 is represented in FIG. 1 by the area 12 and the first location 10 represents the of shown in FIG. 6 with a small part of the desk shown thereon identified. As a result using five sets of three coordinates a location of approximately 10×10 centimetres is identified from a map of the British Isles. The zooming can be repeated ad infinitum allowing a high degree of accurate positioning data with very little data required in terms of the coordinates used.

A further embodiment of the present invention can utilise the grid system previously described as part of an asset management system. However, it should be noted that other grid-based mapping systems could also be used to implement this embodiment of the invention. This asset management system can be utilised to organise the records of organisations with assets and the term asset not only defines objects owned by the organisation but can also include objects temporarily in the possession of the organisation, work spaces used by the organisation, other spaces used by the organisation and can be used to maintain and organise other records such as personnel records and financial information. The asset data management runs on a computer device and this can be a single computer device or a series of linked together computer devices. In order to operate the system using a computer device, a data storage device is required, for example a hard drive, although any other data storage device can also be used. A data processing device, such as a central processing unit is also required although other data processing units would also be suitable. A display device, such as a screen, is a further requirement as well as a data input interface, such as a keyboard, mouse or on screen input system. It is again the case that the above listed examples are merely a few examples of suitable systems and other systems will be familiar to those skilled in this field. The computer device may be a single hand held device, may be a series of linked devices or may be a desktop or laptop computer either linked or not linked to a server device. Ideally, the present system is utilised using a central server storage device with data processing capacity thereon linked to hand held, laptop or desktop computers which also have data processing capabilities, display screen and data input capabilities.

The data storage device of the present invention stores a variety of data for the purposes of asset management. This data includes map data for allowing a map or plan of a building or area to be displayed on a display device. This map data may be a simple floor layout plan and may be stored as a JPEG image file, or as any other form of image file.

Ideally, the map data is stored in vector form so that the map image can be zoomed in on without degradation of the image.

The data also includes grid data for allowing a plurality of grids to be displayed on the display device. Preferably the grids are of the type previously described and grid sectors within the grids can be defined using a three co-ordinate system. A plurality of grids are defined by the grid data so that one or more of the grid sectors defines a second grid with the extremities of the second grid substantially equating to the edges of the grid sector in the first grid. The grid data is not limited to first and second layers of grids and multiple layers of grids are provided to accommodate all of the data that is utilised in the present invention.

The data also includes asset data which can be divided into asset feature data, which is data relating to the asset itself and asset location data, which is data about where the asset is located. In some instances the asset location data is not relevant, in particular for mobile assets, such as vehicles, unless the asset is tracked using an asset tracking device which feeds location data on a regular basis to the asset management system. Similarly, data relating to personnel may be stored in the data management system of the present invention and such personnel data may not include a location, although it may include a standard working location for that person. The asset feature data may include significant amounts and different types of data depending on the asset in question. Data may include raw data, for example numerical data such as dimensions, date of purchase, data next service due, supplier, servicing contractor and the like. The asset data may also include pre-processed data which could for example include copies of documents relevant to the asset, such as service manuals, operational manuals, hire purchase agreements, service agreements, images of the asset and the like.

Also stored on the data storage device is logic test data, this being logic queries that can be applied to at least some of the asset data, in particular either the asset location data or the raw asset feature data.

The data storage device further stores linking data that provides a link between grid sectors and other data stored in the data storage device. This link makes a connection between a grid sector, in a particular grid layer, to further forms of data also stored on the data storage device. For example, the linking data can link a grid sector to one or more asset data. The linking data can also link a grid sector to a further grid, thereby producing the layers of grids as previously described. Furthermore, the linking data can also link a grid sector to a logic test stored in the logic test data. These links may well chain together for example, if a first sector on a first map is linked to an enlarged portion of the first map (thereby forming a second map) with a grid overlaying it and a second sector on that second map is linked to an asset, that asset is linked to both the first and second sectors. The chained links ultimately connect grid sectors with assets.

A data processor, either within the same device or in an associated device, processes the data stored on the storage device and creates images representing the assets on a display device. The processing device uses the map data to produce a map, typically representing a building, over which a grid is laid based on the grid data. The grid contains selectable sectors, either all sectors are selectable within the grid or alternatively some sectors, within which there is no further information, for example sectors that lie outside the building in question, may not be selectable by user. An input device is used by a user to select a sector and this selection results in a further action. These actions include displaying a portion of the map data that was contained within the selected sector and displaying a further grid overlaying this enlarged map. This function can be seen as a zooming in function, where selection of a sector causes the processing device to zoom into the map at the selected sector. A sector may alternatively link to at least one datum of the asset data which may then be displayed. For example, it may link to a particular document and selection of the sector may result in display of that document on the display device. Alternatively the asset data may be raw data in which case the display device may display one or more items of asset data either directly as the raw data or in some representation or conversion of the raw data, for example into a chart. Selecting a sector may apply a logic test defined by the logic test data and result in displaying an output from that logic test.

One example of such a logic test is that the test identifies all grid sectors that are linked, by the linking data, to at least one item of the asset data defined in the logic test. For example, if a logic test defines a particular document associated with an asset, the logic test can be to identify all assets that are linked to that document. Further examples of this linkage are set out below.

Referring in particular to FIGS. 7 and 8, a first screen 100 includes a map area 102 which shows a plan of a building. Overlaid on the plan of the building is a grid formed from the grid data. The grid contains four quadrants 104, 106, 108 and 110, that are identified by the use of coloured lines, as previously described. Each quadrant is divided into 144 grid sectors that are identified using co-ordinates 1-12 and A-L, also substantially as previously described. The view shown in FIG. 8a is a typical opening view used in the present invention and represents a site plan for a whole building. Located in some grid sectors are icons such as those labelled 112, 114, 116, 118 and 120. Whether icons are shown or not is determined by their selection and deselection in side bar 122. Where multiple assets of the same type are contained within a single sector, a small number is shown in the bottom right hand corner such as that indicated at 124. Some grid sectors do not contain any icons, such as those shown at 126.

A user interface such as a keyboard or mouse or touch screen, allows selection of a grid sector. If an empty grid sector, such as that shown at 126, is selected, a further map is displayed in which the extremities of the newly displayed map 128, equate to the edges of sector 126 that was selected. This newly displayed map 128 may contain further icons that can be displayed in sectors of the grid overlaying the map 128. If such a sector containing an icon, with no number indicating multiple assets in the same sector, is selected, or had previously been selected in map 102, such as the icon 118, data relating to the asset represented by icon 118 is displayed at 130 with a further grid overlay. The background to this grid is no longer a map and is instead, in this example, an image representing the asset in question, in this case a file server. This image could be a schematic image, such as that used in the illustrative figures, or could be a photograph of the asset in its location. The majority of sectors in this further display 130 are inactive although two rows of four active sectors, 132, 134, 136, 138, 140, 144, 146 and 148, provide further links. The sectors 132, 134, 136 and 138 provide links to asset feature data which could for example be scanned documents as schematically represented at 150. These documents could include insurance documents, instruction manuals, photographs of the apparatus, but the asset data could alternatively be raw data that is displayed on the display device.

Sectors 140, 144, 146 and 148 represent logic tests which can relate to the asset data of the sectors above. For example, selection of grid sector 132 may display a servicing schedule for various assets that include the assets shown. The logic test linked to sector 140 may then be a logic test identifying all assets that are identified in that service schedule. This is produced in the straightforward manner of identifying all of the links from grid sectors to that asset data, the service schedule document. These linked sectors are also linked to asset data and therefore a list of the asset data can be produced, as shown at 152 or a map may be shown at 154 with the location of each of those assets identified. As a result, the logic test acts like a backward stepping hyperlink, or back button, in a web browser but instead of retracing the linear steps taken through displays 130, 128 and 102, the alternative display 154 showing multiple linked assets is displayed instead.

A variety of other logic tests can also be applied. For example, a further limitation to the above described logic test may be to add in the further test that once all linked assets are identified only those whose servicing is scheduled within the next few months need be displayed. This alternative logic test can be provided in a different sector.

It is also the case that logic tests can be applied across all of the asset data at any time. For example, where asset feature data includes dates where certain action must be taken, for example where servicing is required or where insurance renewal is required, can be highlighted. In such an example, a coloured icon might be used to indicate the time period before action must be taken utilising a traffic light system where urgent action is indicated in red, less urgent action in yellow and where no action is required in green. The display can be tailored for the person who is accessing the system dependent upon the requirements of their job. For example, a person working in a finance department may be only concerned about insurance details and therefore may not wish to see information relating to servicing contracts. In contrast, a person working in the maintenance department may only be interested in the servicing contracts and not in the insurance aspects. As a result, when they access the system, only the information relevant to them will generally be displayed, although an override may be provided to allow them access to further information.

In a further alternative, it may be the case that the first screen/grid that is encountered by a user is not the first map shown in FIG. 8a, but is in fact a grid on its own or with some other background, perhaps a company logo. The live grid sectors in this embodiment would lead to various other grids, one of which being the map grid, but others could relate to personnel records or financial records all of which utilise the grid based linking system and allow the non-linear backward display of multiple records that are linked together in the manner described above.

It will be appreciated by persons skilled in the art that the above embodiments have been described by way of example only, and not in any limitative sense, and that various alterations and modifications are possible without departure from the scope of the invention as defined by the appended claims. For example, the sub-areas used need not be identified using colours, alternative identification distance such a line thickness or line type, (for example dotted or dashed) can be used. Furthermore the sub-areas 16 are not limited to four further colours or other identifiers can be used and the arrangement of the sub-areas need not be a square as shown. For example rectangular or L-shaped arrangements may be more suitable for the type of building that is being mapped.

1. An asset management system comprising:—
at least one data storage device for storing data, the data including:
map data for allowing a map or plan to be displayed on a display device;
grid data for allowing a plurality of grids to be displayed on a display device, each grid formed from a plurality of grid sectors, the grid data forming at least one first grid and at least one second grid the extremities of said second grid being substantially the edges of a sector of said first grid;
asset data including asset location data relating to a location of an asset and asset feature data relating to features of said asset;
logic test data relating to at least one logic test that can be applied to at least some of said asset data;
linking data for linking grid sectors to other data wherein grid sectors are linked to one or more of:
a further grid, the extremities of said further grid being the edges of said selected grid section;
at least one datum of said asset data; and
at least one said logic test data; and
at least one processing device for processing said data and displaying, on at least one display device, at least one first map image representing at least some of said map data and at least one grid representing at least some of said grid data, said processing device adapted to receive input data relating to the selection of a grid sector by a user, wherein said selection causes said processing device to process at least some of said data to produce at least one of the following actions:
displaying a portion of said map data contained within said selected sector and display a further grid;
displaying at least one datum of said asset data; and
applying a logic test defined by said logic test data and displaying the results thereof,
wherein at least one of said logic tests is to identify all grid sectors that are linked by said linking data to at least one asset feature datum defined in the logic test.

2. An asset management system according to claim 1, wherein said grid data is divided into grid sectors by dividing said grid into a plurality of sub-areas, each sub-area identifiable by a coordinate, applying a matrix to each sub-area dividing the sub-area to give a plurality of grid-areas in each sub-area, each grid-area identifiable by a pair of coordinates, and identifying a grid sector in said grid by providing sub-area and grid-area information as at least 3 said coordinates.

3. An asset management system according to claim 1, wherein said asset location data is defined with reference to said grid data.

4. An asset management system according to claim 1, wherein said asset feature data includes at least one of documents related to said asset, images related to said asset, dimensions related to said asset and persons authorised to use said asset.

5. An asset management system according to claim 1, wherein said logic test data includes applying a logic test to at least one of said asset feature data, said asset location data and said linking data.

6. An asset management system according to claim 1, wherein when at least one datum of said asset data is displayed at least one grid is also displayed and at least one sector of said grid is linked to at least one other asset datum.

7. (canceled)

8. An asset management method comprising the steps:—
storing data on at least one data storage device, the data including:
map data for allowing a map or plan to be displayed on a display device;
grid data for allowing a plurality of grids to be displayed on a display device, each grid formed from a plurality of grid sectors, the grid data forming at least one first grid and at least one second grid the extremities of said second grid being substantially the edges of a sector of said first grid;
asset data including asset location data relating to a location of an asset and asset feature data relating to features of said asset;
logic test data relating to at least one logic test that can be applied to at least some of said asset data;
linking data for linking grid sectors to other data wherein grid sectors are linked to one or more of:
a further grid, the extremities of said further grid being the edges of said selected grid section;
at least one datum of said asset data; and
at least one said logic test data; and
processing said data, on at least one processing device, and displaying, on at least one display device, at least one first map image representing at least some of said map data and at least one grid representing at least some of said grid data,
receiving, on said processing device, input data relating to the selection of a grid sector by a user, wherein said selection causes said processing device to process at least some of said data to produce at least one of the following actions:
displaying a portion of said map data contained within said selected sector and display a further grid;
displaying at least one datum of said asset data; and
applying a logic test defined by said logic test data and displaying the results thereof,
wherein at least one of said logic tests is to identify all grid sectors that are linked by said linking data to at least one asset feature datum defined in the logic test.

9. An asset management method according to claim 8, wherein said grid data is divided into grid sectors by dividing said grid into a plurality of sub-areas, each sub-area identifiable by a coordinate, applying a matrix to each sub-area dividing the sub-area to give a plurality of grid-areas in each sub-area, each grid-area identifiable by a pair of coordinates, and identifying a grid sector in said grid by providing sub-area and grid-area information as at least 3 said coordinates.

10. An asset management method according to claim 8, wherein said asset location data is defined with reference to said grid data.

11. An asset management method according to claim 8, wherein said asset feature data includes at least one of documents related to said asset, images related to said asset, dimensions related to said asset and persons authorised to use said asset.

12. An asset management method according to claim 8, wherein said logic test data includes applying a logic test to at least one of said asset feature data, said asset location data and said linking data.

13. An asset management method according to claim 8, wherein when at least one datum of said asset data is displayed at least one grid is also displayed and at least one sector of said grid is linked to at least one other asset datum.

14. (canceled)

15. An asset management computer program comprising:—
first computer code for storing data on at least one data storage device, the data including:
map data for allowing a map or plan to be displayed on a display device;
grid data for allowing a plurality of grids to be displayed on a display device, each grid formed from a plurality of grid sectors, the grid data forming at least one first grid and at least one second grid the extremities of said second grid being substantially the edges of a sector of said first grid;
asset data including asset location data relating to a location of an asset and asset feature data relating to features of said asset;
logic test data relating to at least one logic test that can be applied to at least some of said asset data;
linking data for linking grid sectors to other data wherein grid sectors are linked to one or more of:
a further grid, the extremities of said further grid being the edges of said selected grid section;
at least one datum of said asset data; and
at least one said logic test data; and
second computer code for processing said data, on at least one processing device, and displaying, on at least one display device, at least one first map image representing at least some of said map data and at least one grid representing at least some of said grid data,
third computer code for receiving, on said processing device, input data relating to the selection of a grid sector by a user, wherein said selection causes said processing device to process at least some of said data to produce at least one of the following actions: displaying a portion of said map data contained within said selected sector and display a further grid;
displaying at least one datum of said asset data; and
applying a logic test defined by said logic test data and displaying the results thereof,
wherein at least one of said logic tests is to identify all grid sectors that are linked by said linking data to at least one asset feature datum defined in the logic test.

16. An asset management computer program according to claim 15, wherein said grid data is divided into grid sectors by dividing said grid into a plurality of sub-areas, each sub-area identifiable by a coordinate, applying a matrix to each sub-area dividing the sub-area to give a plurality of grid-areas in each sub-area, each grid-area identifiable by a pair of coordinates, and identifying a grid sector in said grid by providing sub-area and grid-area information as at least 3 said coordinates.

17. An asset management computer program according to claim 15, wherein said asset location data is defined with reference to said grid data.

18. An asset management computer program according to claim 15, wherein said asset feature data includes at least one of documents related to said asset, images related to said asset, dimensions related to said asset and persons authorised to use said asset.

19. An asset management computer program according to claim 15, wherein said logic test data includes applying a logic test to at least one of said asset feature data, said asset location data and said linking data.

20. An asset management computer program according to claim 15, wherein when at least one datum of said asset data is displayed at least one grid is also displayed and at least one sector of said grid is linked to at least one other asset datum.

21. (canceled)

22. A method for enabling a person to identify a first location within an area, the method comprising:—
providing an image, in the form of a map, representing an area, the image including
divisions of at least part of the image into a plurality of sub-areas, each sub-area identifiable by a coordinate, and
a grid applied to each sub-area to give a plurality of grid-areas in each sub-area, each grid-area identifiable by a pair of coordinates; and
identifying a location in said area by providing sub-area and grid-area information as at least 3 said coordinates.

23. A method according to claim 22, wherein systems for identifying said 3 coordinates are different for each of the 3 coordinates.

24. A method according to claim 23, wherein said systems include three of colours; letters; numbers; and, line thicknesses.

25. (canceled)

26. An apparatus for enabling a person to identify a first location within an area, the method comprising at least one display device for displaying an image, in the form of a map, representing an area, the image including
divisions of at least part of the image into a plurality of sub-areas, each sub-area identifiable by a coordinate, and
a grid applied to each sub-area to give a plurality of grid-areas in each sub-area, each grid-area identifiable by a pair of coordinates
wherein a location in said area can be identifies by providing sub-area and grid-area information as at least three said coordinates.

27. An apparatus according to claim 26, further comprising a device for displaying on said map at least one icon representing at least one device at a location in said space and a device for communicating said coordinates equivalent to said location.

28. An apparatus according to claim 27, wherein systems for identifying said three coordinates are different for each of the three coordinates.

29. An apparatus according to claim 28, wherein said systems include three of colours; letters; numbers; and, line thicknesses.

30. (canceled)

31. A computer program for enabling a person to identify a first location within an area, the method comprising:—
first computer code for creating an image, in the form of a map, representing an area, the image including
divisions of at least part of the image into a plurality of sub-areas, each sub-area identifiable by a coordinate, and
a grid applied to each sub-area to give a plurality of grid-areas in each sub-area, each grid-area identifiable by a pair of coordinates; and
second computer code for identifying a location in said area by providing sub-area and grid-area information as at least three said coordinates.

32. A computer program according to claim 31, wherein systems for identifying said three coordinates are different for each of the three coordinates.

33. A computer program according to claim 32, wherein said systems include three of colours; letters; numbers; and, line thicknesses.

34. (canceled)

35. A computer program product for enabling a person to identify a first location within an area the product comprising a data carrier and a computer program according to claim 31.
